(19) United States
(12) Patent Application Publication
(10) Pub. No.: US 2003/0167741 A1
(43) Pub. Date: Sep. 11, 2003

(54) Combined toroidal and cylindrical vortex dust separator

(76) Inventors: Lewis Illingworth, Kensington, NH (US); David Reinfeld, Englewood, NJ (US)

Correspondence Address: Ward & Olivo, Suite 300, 382 Springfield Avenue, Summit, NJ, 07901, US

(21) Appl. No.: 10/371,241

(22) Filed: Feb. 20, 2003

Related U.S. Application Data
(63) Continuation-in-part of application No. 10/025,376, filed on Dec. 19, 2001.
Application No. 10/025,376 is a continuation-in-part of application No. 09/835,084, filed on Apr. 13, 2001.
Application No. 09/835,084 is a continuation-in-part of application No. 09/829,416, filed on Apr. 9, 2001.
Application No. 09/829,416 is a continuation-in-part of application No. 09/728,602, filed on Dec. 1, 2000.
Application No. 09/728,602 is a continuation-in-part of application No. 09/316,318, filed on May 21, 1999, now Pat. No. 6,595,753.

(51) Int. Cl. B01D 45/14

(52) U.S. Cl. 55/406

(57) ABSTRACT

The present invention is a novel matter separation apparatus which utilized the combined effects of cylindrical and toroidal vortices. The combined effect provides better separation than either alone. Moreover, the present invention can effectively increase the efficiency of separation without limiting the amount throughput capacity of the system. Therefore, the present invention provides effective means for separating solid particles from fluid flow.

### CROSS REFERENCE TO OTHER APPLICATIONS

This application is filed as a continuation-in-part of co-pending application entitled “Filterless Folded and Ripple Dust Separators and Vacuum Cleaners Using the Same,” filed Feb. 19, 2003, which is a continuation-in-part of co-pending application entitled “Axial Flow Centrifugal Dust Separator,” filed Dec. 12, 2002, which is continuation-in-part of co-pending application Ser. No. 10/025,376 entitled “Toroidal Vortex Vacuum Cleaner Centrifugal Dust Separator,” filed Dec. 19, 2001, which is a continuation-in-part of co-pending application Ser. No. 09/835,084 entitled “Toroidal Vortex Bagless Vacuum Cleaner,” filed Apr. 13, 2001, which is a continuation-in-part of co-pending application Ser. No. 09/829,416 entitled “Toroidal and Compound Vortex Attractor,” filed Apr. 9, 2001, which is a continuation-in-part of co-pending application Ser. No. 09/728,602, filed Dec. 1, 2000, entitled “Lifting Platform,” which is a continuation-in-part of co-pending Ser. No. 09/316,318, filed May 21, 1999, entitled “Vortex Attractor.”

### TECHNICAL FIELD OF THE INVENTION

The present invention relates to an improved centrifugal and toroidal vortex dust separator. Specifically, the improved dust separator centrifugally separates dust by ejecting particles into a collector. However, the cylindrical vortex flow in the separator is supplemented by a toroidal vortex flow. The combined effect of the these fluid flows yields a more efficient and complete separation than other devices in the art.

### BACKGROUND OF THE INVENTION

Centrifugal separation is a well known technique in the art of separation, including separation of solids from liquids, liquids from gases, and liquids from liquids. There are several ways to carry out this technique.

For instance, FIG. 1 depicts a perspective view of Applicant's invention disclosed in co-pending application “Axial Flow Centrifugal Dust Separator,” filed Dec. 12, 2002. Separator 100 comprises housing 105, impeller 102, rotating drum 103, and annular separation chamber 104. Fluid flow 101 travels through the separation chamber 104 in a cylindrical vortex with radius R. Dust and debris are thrown outward into a collector (not shown). Yet, the art has not fully benefited from the use of toroidal vortex fluid flow in conjunction with cylindrical vortex fluid flow. By only utilizing a cylindrical vortex fluid flow, the effectiveness of separation is limited. To verify this, the forces maintaining a cylindrical vortex fluid flow must be analyzed. Generally, particles in a cylindrical vortex exhibit an acceleration equal to V²/R, wherein V=tangential speed of the particle and R=radius of the cylindrical vortex. Thus, in order to maintain a cylindrical vortex fluid flow, a net force equal to mV²/R, wherein m=mass of a particle, must be applied to each particle. In centrifugal separation, dust and debris particles have larger masses than fluid particles, therefore requiring a larger force to hold them into the cylindrical vortex. Separation occurs when mV²/R is made sufficiently high such that dust and debris particles cannot be held within the cylindrical vortex, and consequently, are ejected. Because m is constant, mV²/R can be increased only by increasing V or decreasing R. V can be increased depending on the limitations of the system, i.e., power of the motor, strength of the apparatus, etc. There are also limitations on how far R may be decreased because a decrease in R will also decrease the cross-sectional area of the separator, thereby limiting the throughput of the device.

By combining a toroidal vortex fluid flow with the cylindrical vortex fluid flow discussed supra, the limitations of R can be overcome. Side and perspective views of a simplified version of this combined fluid flow are depicted in FIGS. 2A and 2B, respectively. The actual fluid flow comprises multiple layers contained within each other. The combined flow has an overall radius R similar to that described for a cylindrical vortex. The combined fluid flow also has an inner radius r that is significantly smaller than overall radius R. Within the toroidal component of fluid flow (i.e., rotation around inner radius r) the tangential velocity is v and thus, a force of mv²/r is required to hold a particles within this fluid flow. Because r is so small, this force will be relatively high. Moreover, the force required to hold dust and debris particles within the combined fluid flow is significantly higher than the force required for either a cylindrical vortex or a toroidal vortex alone. The combined fluid flow will ultimately produce a more efficient and complete separation than cylindrical vortex fluid flow or toroidal vortex fluid flow alone. Such an efficient separation allow dust and debris to be ejected from the fluid flow more quickly and completely. The present invention takes advantage of the benefits of the combined fluid flow to effect efficient separation of solids within a fluid.

Although the present invention is unique and novel, in order to fully understand it in its proper context, the following references are provided.

Specifically, the references of Mignot U.S. Pat. No. 5,401,422; Moredock U.S. Pat. Nos. 5,656,050 and 5,766,315; and Jen U.S. Pat. No. 6,461,513 B1 relate to the present invention.

Mignot U.S. Pat. No. 5,401,422 discloses a filter system capable of preventing the clogging of the filter. Specifically, Mignot utilizes a cylindrical housing containing a concentrically-placed, cylindrically-shaped filter. A fluid inlet and fluid outlet are placed on opposing sides of the housing. An additional fluid outlet is concentrically placed at the end of the filter. In operation, the filter rotates while “dirty” fluid enters via the fluid inlet. As fluid flows in the annular duct between the housing and the filter, the fluid rotates into a cylindrical vortex. When the rotational velocity is high enough, a series of counter-rotating toroidal vortices form in the annular duct. The vortex fluid flow throws particles outward while allowing some fluid to flow inward. The fluid flowing inward passes through the filter and exits the fluid outlet therein. The remaining “dirty” fluid flow exits the fluid outlet of the housing. Because of the fluid flow throwing particles outward, particles cannot clog the rotating filter.

The present invention preferably operates without a filter. Additionally, the present invention does not need two fluid outlets (one for “dirty” fluid and one for “clean” fluid flow) as Mignot does. Instead, the present invention efficiently separates dust and debris or any other type of matter from fluid flow, retains it within a collector, and outputs sufficiently cleaned fluid flow.

Moredock U.S. Pat. Nos. 5,656,050 and 5,766,315 discloses a centrifugal separator that ejects particles radially. In order to create a cyclone, Moredock directs the air entering the cyclone chamber tangentially with respect to the chamber's wall. Therefore, the chamber's wall forces the air into the cyclone flow pattern. Additionally, the speed of airflow in the cyclone is that of the incoming flow. Further, Moredock ejects particles from the dome via a slot running vertically along the wall. The slot leads into a duct traveling away from the apparatus. Thus, the duct allows air to exit along with the particles.

It would be preferable to create the cylindrical flow and the necessary suction in a single step. Such an arrangement has energy and efficiency advantages. Also, it would be desirable to spin incoming fluid at the blade speed of an impeller, and consequently, achieve a higher rate of rotation than is possible with Moredock's configuration. Furthermore, it would be preferable to keep the dust-laden fluid within the system to prevent dust from escaping into the atmosphere; and not allow fluid to exit until it has been sufficiently cleaned. The present invention accomplishes these things, but Moredock does not.

Jen U.S. Pat. No. 6,461,513 B1 disclose a cylindrically shaped filter system utilizing Dean Flow. Here, fluid flow is guided along a spiral pathway around a cylindrical filter. When fluid flow reaches a critical flow velocity, Dean Flow currents are developed as opposing pairs of corkscrew vortices that travel along the spiral fluid flow path. Dean Flow creates a strong shear cleaning current along the filter surface preventing particles from becoming entrapped by the filter. The fluid that flows through the filter exits the system as filtrate while the fluid flow that remains in the spiral path exits as concentrate. Conversely, the present invention eliminates the need for filters and does not have separate concentrate and filtrate output. Rather, all fluid flow that enters the present invention can leave as clean as the user desires.

Thus, there is a clear need for a simple, light weight, efficient, quiet, and filterless separator using both toroidal and cylindrical vortices. The art is devoid of such a device, but the present invention meets these needs.

### SUMMARY OF THE INVENTION

The technology disclosed herein extends from and improves upon technology disclosed in the co-pending application entitled “Filterless Folded and Ripple Dust Separators and Vacuum Cleaners Using the Same,” filed Feb. 19, 2003, which is hereby incorporated herein by reference. This application is an extension of and improvement upon matter disclosed in co-pending application entitled “Axial Flow Centrifugal Dust Separator,” filed Dec. 12, 2002, which is hereby incorporated herein by reference. This application extends from and advances upon technology from Applicant's invention disclosed in co-pending application Ser. No. 10/025,376 entitled “Toroidal Vortex Bagless Vacuum Cleaner Centrifugal Dust Separator,” filed Dec. 19, 2001, which is hereby incorporated herein by reference. Furthermore, the separator of this application is an improvement extending from technology disclosed in co-pending application Ser. No. 09/835,084 entitled “Toroidal Vortex Bagless Vacuum Cleaner,” filed Apr. 13, 2001, which is hereby incorporated herein by reference. Additionally, the bagless vacuum cleaner of this invention is an advancement extending from technology disclosed in the co-pending application Ser. No. 09/829,416 entitled “Toroidal and Compound Vortex Attractor,” filed Apr. 9, 2001, which is hereby incorporated herein by reference. The attractors disclosed therein improve upon technology extending from matter disclosed in co-pending application Ser. No. 09/728,602 entitled “Lifting Platform,” filed on Dec. 1, 2000, which is hereby incorporated herein by reference. Finally, the lifting platform technology is an extension advancing over technology disclosed in co-pending application Ser. No. 09/316,318 entitled “Vortex Attractor,” filed May 21, 1999, which is hereby incorporated herein by reference.

As indicated above, the present invention is an improvement upon the centrifugal separators of parent applications. Therein, cylindrical vortices are formed such that a circular pattern of flow exiting from the impeller spirals along the separation chamber's outer wall. The cylindrical flow of the fluid acts as a centrifuge, forcing the higher mass dust particles outward. The spiraling fluid also creates a pressure in the collector greater than the pressure in the separation chamber due to the kinetic energy of the circulating fluid. This high pressure pushes the spiraling fluid inward, maintaining the fluid's circular path. However, the dust particles are not inhibited from traveling straight into the collector.

Unlike traditional centrifugal separation, the separators disclosed herein spin fluid at the blade speed of the impeller. Thus, the system acts like a high speed centrifuge capable of removing very small particles from the fluid flow. Additionally, the present invention guides fluid flow into a partial toroidal vortex having a very small inner radius. Because this radius is so small, particles are more effectively removed from the fluid flow. Moreover, the combined toroidal and cylindrical fluid flows effect more efficient separation than either alone. Thus, no vacuum bags, liquid baths, or filters are required.

One of the main features of the present invention is the inherently low power consumption. Specifically, conventional bags and filters resist fluid flow, thus requiring greater power to maintain a given flowrate. Operating without bags or filters, the present invention circumvents this problem. Additionally, since only smooth directional changes of fluid flow are made in the present invention, the effect on the energy of the moving fluid is minimal. Furthermore, the design is expected to be virtually maintenance free.

Also, the possibility of excessive fluid flow into and out of the collector of the present invention can be disruptive. This may be minimized, however, by strategically placing baffles inside the collector. Alternatively, electrostatically charged members may be placed within the collector to attract and capture dust and debris. Additionally, valves may also be placed at the inlet or outlet of the separator in order to regulate fluid flow. By controlling fluid flow with valves, the efficiency can be maximized for a variety of circumstances.

In an alternative embodiment of the present invention, the entire separator may rotate with the impeller. Because the collector is rotating, the dust and debris are forced to the outer wall and consequently, will have a lesser chance to escape.

Thus, it is an object of the present invention to utilize cylindrical vortices in a separator application.

Further, it is an object of the present invention to utilize toroidal vortices in a separator application.

Moreover, it is an object of the present invention to utilize the combined effects of toroidal and cylindrical vortices in a separator application.

Additionally, it is an object of the present invention to provide an efficient separator.

It is a further object of the present invention to provide a lightweight separator.

In addition, it is an object of the present invention to provide a low-maintenance separator.

It is yet another object of the present invention to provide a bagless separator.

It is a further object of the present invention to provide a dust separator that does not require filters.

It is also an object of the present invention to provide non-rotating, substantially dust-free and debris-free fluid as a product.

Also, it is an object of the present invention to provide a dust separator that minimizes exchange of fluid between the separation chamber and collector.

Additionally, it is an object of the present invention to provide an axial flow design to adapt the dust separator for general use.

Moreover, it is an object of the present invention to smoothly guide fluid flow through a separation system.

These and other objects will become readily apparent to one skilled in the art upon review of the following description, figures, and claims.

### SUMMARY OF THE DRAWINGS

A further understanding of the present invention can be obtained by reference to preferred and alternative embodiments set forth in the illustrations of the accompanying drawings. Although the illustrated embodiments are merely exemplary of systems for carrying out the present invention, both the organization and method of operation of the invention, in general, together with further objectives and advantages thereof, may be more easily understood by reference to the drawings and the following description. The drawings are not intended to limit the scope of this invention, which is set forth with particularity in the claims as appended or as subsequently amended, but merely to clarify and exemplify the invention.

For a more complete understanding of the present invention, reference is now made to the following drawings in which:

FIG. 1 (FIG. 1) (PRIOR ART) depicts a perspective view of a cylindrical vortex separator;

FIGS. 2A and 2B (FIGS. 2A and 2B) depict side and perspective views, respectively, of a combined toroidal vortex and cylindrical vortex fluid flow;

FIG. 3 (FIG. 3) depicts a side, cross-sectional view of a combined toroidal and cylindrical vortex separator of the preferred embodiment of the present invention;

FIG. 4 (FIG. 4) depicts a perspective view of an impeller assembly for use with the preferred embodiment of the present invention; and

FIGS. 5A and 5B (FIGS. 5A and 5B) depict alternative impeller assemblies for use with the present invention.

### DETAILED DESCRIPTION OF THE PREFERRED EMBODIMENTS

As required, a detailed illustrative embodiment of the present invention is disclosed herein. However, techniques, systems and operating structures in accordance with the present invention may be embodied in a wide variety of forms and modes, some of which may be quite different from those in the disclosed embodiments. Consequently, the specific structural and functional details disclosed herein are merely representative, yet in that regard, they are deemed to afford the best embodiments for purposes of disclosure and to provide a basis for the claims herein which define the scope of the present invention. The following presents a detailed description of a preferred embodiment (as well as some alternative embodiments) of the present invention.

Certain terminology will be used in the following description for convenience in reference only and will not be limiting. The words “in” and “out” will refer to directions toward and away from, respectively, the geometric center of the device and designated and/or reference parts thereof. The words “up” and “down” will indicate directions relative to the horizontal and as depicted in the various figures. Such terminology will include the words above specifically mentioned, derivatives thereof, and words of similar import.

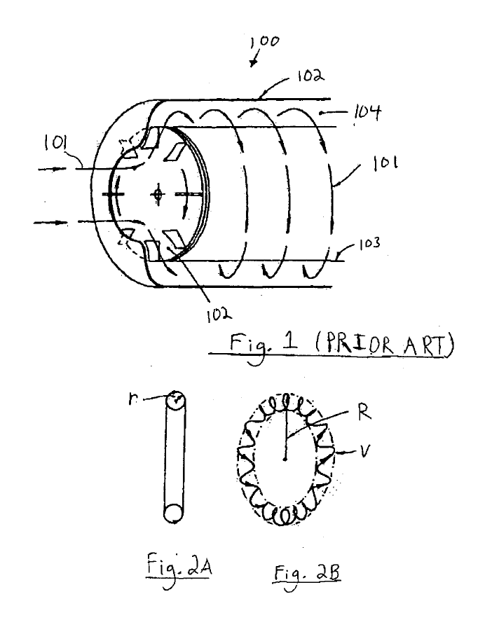

Applicant has disclosed in the parent patent application “Axial Flow Centrifugal Dust Separator” improved centrifugal dust separators designed to accommodate an overall flow in the axial direction with respect to the rotation of the impeller assembly. A perspective view of such a separator is illustrated in FIG. 1.

As seen in FIG. 1, fluid flow 101 travels in a cylindrical vortex. As discussed supra, effective separation is achieved by maximizing V²/R (wherein V=speed of fluid flow and R=radius of the cylindrical vortex). Speed V can be limited by constraints of the system. Decreasing radius R also decreases the cross-sectional area (πR²) through which fluid flow 101 travels, thereby decreasing the throughput capacity of the device. Therefore, there is a tradeoff between increased separation and throughput capacity of the device. Consequently, the present invention is designed such that separation can be increased without jeopardizing throughput.

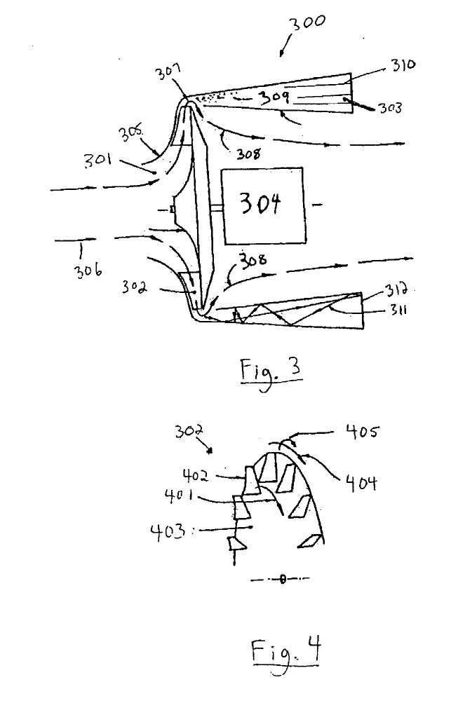

Specifically, the present invention imparts an additional toroidal vortex fluid flow to supplement the cylindrical vortex fluid flow. FIGS. 2A and 2B show side and perspective views of a simplified version of such combined fluid flow. The actual flow comprises multiple layers within each other. This fluid flow comprises two radii, overall radius R and inner radius r. As seen, inner radius r is significantly smaller than overall radius R. However, cross-sectional area πR² may remain unchanged while the effect of having small inner radius r provides for a much larger level of separation. Moreover, the combined effects of toroidal and cylindrical vortices effect more efficient separation than either alone without jeopardizing the cross-sectional area of the separator.

The present invention is designed to produce a combined toroidal and cylindrical vortex fluid flow to in a separation apparatus. The preferred embodiment of the present invention is depicted in FIG. 3. Combined toroidal and cylindrical vortex separator 300 comprises inlet 301, impeller 302, annular collector 303, motor 304, and housing 305. In operation, motor 304 spins impeller 302 to move fluid flow 306 through the system. When fluid flow 306 reaches the outer edge of impeller 302, a cylindrical vortex spinning at the rotational velocity of impeller 302 is created. As fluid flow progresses through the system, a toroidal vortex is also created around the edge of impeller 302 along flow path 307 (having inner radius r). The toroidal vortex component along flow path 307 is maintained by a high pressure built up in annular collector 303. This high pressure maintains the toroidal vortex of fluid flow 306 without impeding dust and debris particles from being ejected into annular collector 303.

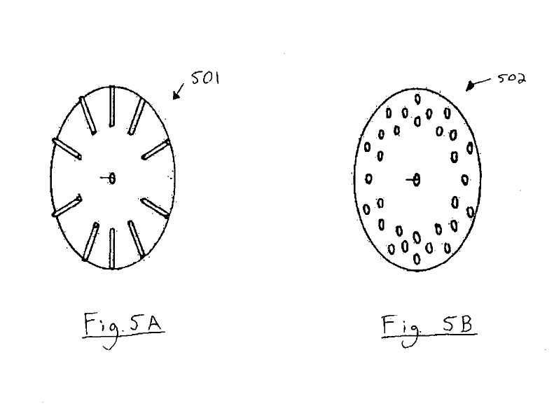

A perspective view of impeller 302 in FIG. 4 provides a more detailed illustration of the fluid flow components and individual parts of impeller 302. Impeller 302 comprises blades 402 and backplate 403. Blades 402 are shown as flat but may be curved. Arrow 401 indicates the rotation of the impeller. In this case, it is shown as clockwise. However, the impeller may be rotated in the counterclockwise direction with equal effectiveness. The cylindrical vortex component of fluid flow is indicated by arrow 404. The cylindrical component of fluid flow here has tangential speed V (determined by the rotational velocity of impeller 302) and radius R (determined by the cross-sectional size of combined toroidal and cylindrical vortex separator 300). Likewise, the toroidal vortex component of fluid flow is indicated by arrow 405. This toroidal component of fluid flow has tangential speed v (determined by the system geometry and flowrate through the system) and radius r (determined by the path around the edge of impeller 302). The combined effects of cylindrical and toroidal vortex fluid flow produces better separation than either fluid flow alone.

Returning to FIG. 3, cleaned fluid flow 308 exits the system from impeller 302. Flow straightening vanes (not shown) may be implemented downstream to eliminate the rotational components of fluid flow. After being ejected from fluid flow, dust and debris 309 are ejected into annular collector 303. Baffles 310 may be implemented in annular collector 303 to minimize harmful fluid exchange which can lower efficiency and can allow dust and debris 309 to return to fluid flow 301. Baffles 310 may be electrostatically charged to attract dust and debris 309. Alternatively, annular collector 303 may be tapered as shown to prevent dust and debris 309 from escaping. In the case that no baffles are used, a typical path for an ejected particle in tapered annular collector 303 is shown by path 311. Because of the slowing of the particle's speed due to friction and inelastic bouncing combined with the tapered design of annular collector 303, the particle will not easily escape. Particles may adhere to the walls of annular collector 303 also preventing their escape. End wall 311 of annular collector 303 may be removably constructed to allow annular collector 303 to be easily emptied.

The collection in the present invention does not depend on the amount of dust and debris in the collector as in conventional systems where dust collection deteriorates as dust accumulates. Also, the collection in the present invention does not rely on gravity, and consequently, the separators of the present invention may operate in any orientation. Moreover, the separator of the present invention is capable of collecting various other matter such as sand, screws, dirt, nails, bolts, and other objects.

Combined toroidal and cylindrical vortex separator 300 of the present invention has additional advantages over conventional cyclone separators which create rotational components by tangentially injecting fluid flow into a cyclone chamber. In conventional cyclone separators, if the fluid flow through the system is slowed, the cyclone deteriorates. When the fluid flow resumes, dirty fluid will continue past the separator. In the present invention, a cylindrical vortex is maintained regardless of the speed of fluid flow through the system. Therefore, fluid flow can be cleaned under all conditions.

In the preferred embodiment of FIG. 3, impeller 302 creates the cylindrical vortex fluid flow while moving fluid through the system. If, however, the present invention is implemented into a system in which fluid flow is already moving (e.g., a heating duct or traditional water pipe), an impeller that moves fluid flow through the system may not be necessary. In this case, the fluid flow must only be spun into a cylindrical vortex. In this case ribbed impeller 501 or impeller 502 comprising bumps may be used (illustrated in FIGS. 5A and 5B, respectively) . These impeller designs require significantly less power to operate. Moreover, these impeller designs may be used to move fluid through the system at slow flowrates. In the case of a slow flowrate, inner radius r can be decreased to compensate for the decrease in radial speed v.

In another alternative embodiment of the present invention, housing 305 and annular collector 303 can be made to rotate with impeller 302. This may be done by attaching blades 402 to housing 305. The rotation of annular collector 303 throws dust and debris 309 outward further preventing escape.

While the present invention has been described with reference to one or more preferred embodiments, which embodiments have been set forth in considerable detail for the purposes of making a complete disclosure of the invention, such embodiments are merely exemplary and are not intended to be limiting or represent an exhaustive enumeration of all aspects of the invention. The scope of the invention, therefore, shall be defined solely by the following claims. Further, it will be apparent to those of skill in the art that numerous changes may be made in such details without departing from the spirit and the principles of the invention.

I claim:

1. An apparatus for separating matter from fluid flow comprising:
at least one impeller; and
wherein said impeller induces a cylindrical vortex fluid flow on said fluid flow;
and wherein said fluid flow is guided into at least a partial toroidal vortex;
and wherein said cylindrical vortex fluid flow and said toroidal vortex eject said matter from said fluid flow.

2. An apparatus according to claim 1 further comprising a collector for collecting said matter.

3. An apparatus according to claim 1, wherein said impeller moves fluid flow through said apparatus.

4. An apparatus according to claim 1, wherein said impeller comprises a feature selected from the group consisting of at least one blade, at least one backplate, at least one bump, and at least one rib.

5. An apparatus according to claim 4, wherein said blade is curved.

6. An apparatus according to claim 1 further comprising at least one flow straightening vane.

7. An apparatus according to claim 2, wherein said collector comprises a feature selected from the group consisting of at least one baffle and at least one electrostatically charged member.

8. An apparatus according to claim 2, wherein said collector is annular.

9. An apparatus according to claim 2, wherein said collector is tapered.

10. An apparatus according to claim 1, wherein said impeller is concave.

11. An apparatus according to claim 1, wherein said impeller is convex.

12. An apparatus according to claim 2, wherein said collector rotates with said impeller to prevent escape of said matter from said collector.

13. An apparatus according to claim 12 further comprising a housing, and wherein said impeller comprises at least one blade that is coupled to said housing.

14. An apparatus according to claim 2, wherein pressure in said collector is higher than the pressure in said fluid flow such that the pressure differential resulting therefrom assists the maintenance of said toroidal vortex fluid flow.

15. An apparatus according to claim 1 further comprising at least one valve.

16. An apparatus for separating matter from fluid flow comprising:
cylindrical vortex fluid flow means for creating a cylindrical vortex fluid flow; and
guide means for guiding said fluid flow into at least a partial toroidal vortex;
and wherein said cylindrical vortex fluid flow and said toroidal vortex eject said matter from said fluid flow.

17. An apparatus according to claim 16 further comprising collection means for collecting said matter.

18. An apparatus according to claim 16, wherein said cylindrical vortex fluid flow means moves fluid flow through said apparatus.

19. An apparatus according to claim 16, wherein said cylindrical vortex fluid flow means comprises a feature selected from the group consisting of at least one impeller, at least one blade, at least one backplate, at least one bump, and at least one rib.

20. An apparatus according to claim 19, wherein said blade is curved.

21. An apparatus according to claim 16 further comprising at least one flow straightening vane.

22. An apparatus according to claim 17, wherein said collection means comprises a feature selected from the group consisting of at least one baffle and at least one electrostatically charged member.

23. An apparatus according to claim 17, wherein said collection means is annular.

24. An apparatus according to claim 17, wherein said collection means is tapered.

25. An apparatus according to claim 16, wherein said cylindrical vortex fluid flow means is concave.

26. An apparatus according to claim 16, wherein said cylindrical vortex fluid flow means is convex.

27. An apparatus according to claim 17, wherein said collection means rotates to prevent escape of said matter from said collection means.

28. An apparatus according to claim 27 further comprising a housing, and wherein said cylindrical vortex fluid flow means comprises at least one blade that is coupled to said housing.

29. An apparatus according to claim 17, wherein pressure in said collection means is higher than the pressure in said fluid flow such that the pressure differential resulting therefrom assists the maintenance of said toroidal vortex fluid flow.

30. An apparatus according to claim 16 further comprising at least one valve.

31. A method for separating matter from a fluid flow, said method comprising the steps of:
moving said fluid flow in a cylindrical vortex; and
moving said fluid flow in at least a partial toroidal vortex;
wherein said cylindrical vortex and said toroidal vortex eject said matter from said fluid flow.

32. A method according to claim 31, said method comprising the step of:
collecting said matter after being ejected from said fluid flow.

33. A method according to claim 31, said method comprising the step of:
straightening said fluid flow after ejecting said matter therefrom.

34. A method according to claim 31, said method comprising the step of:
moving said fluid flow axially with respect to said cylindrical vortex.
